(19) United States
(12) Patent Application Publication
(10) Pub. No.: US 2005/0199597 A1
(43) Pub. Date: Sep. 15, 2005

(54) [LASER ANNEALING APPARATUS AND LASER ANNEALING PROCESS]

(76) Inventors: I-Chang Tsao, Hsinchu (TW); Huan-Chao Wu, Hsinchu Hsien (TW); Wu-Hsiung Lin, Hsinchu City (TW); Wen-Cheng Lin, Tainan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/709,036

(22) Filed: Apr. 8, 2004

(30) Foreign Application Priority Data
Mar. 11, 2004 (TW) 93106427

(51) Int. Cl. B23K 26/00

(52) U.S. Cl. 219/121.66; 219/121.83

(57) ABSTRACT

A laser annealing apparatus is disclosed, which is adapted for a laser annealing process. The laser annealing apparatus comprises a laser-generating module, a resistance-measuring module, and a host circuit module, wherein the laser-generating module provides a laser beam to recrystallize an amorphous silicon thin film to form a polysilicon thin film. The resistance-measuring module is adapted for measuring the sheet resistance of the polysilicon thin film. Besides, the host circuit module is electrically coupled to and between the laser-generating module and the resistance-measuring module. The host circuit module outputs a feedback signal to the laser-generating module in accordance with the sheet resistance value. Then, the energy density of the laser beam is optimized. The laser annealing apparatus can improve the quality of the thin film, and increase the yield rate of the laser annealing process.

### CROSS REFERENCE TO RELATED APPLICATIONS

This application claims the priority benefit of Taiwan application serial no. 93106427, filed Mar. 11, 2004.

### BACKGROUND OF INVENTION

1. Field of the Invention

The present invention relates to a thin film transistor manufacturing process, and more particularly to a laser annealing process of a low-temperature polysilicon thin film transistor.

2. Description of Related Art

By the advance of technology, video products, especially digital video or image devices, have been widely used. For the time being, the digital video or image devices getting the most attention is thin film transistor liquid crystal display (TFT LCD). In a variety of thin film transistors, polysilicon thin film transistors have electron mobility over 200 cm²/V-sec that is higher than that of amorphous silicon thin film transistors. Therefore, the dimension of the thin film transistor is reduced and the aperture ratio thereof is increased. Accordingly, the brightness of displays is enhanced and the power consumption is reduced.

Prior art method of fabricating the polysilicon thin film transistor uses the solid phase crystallization (SPC) process. Because of its high processing temperature, up to 1000° C., a substrate, such as quartz substrate, with high melting point is required. Moreover, the quartz substrate is more expensive than the glass substrate. By the limitation of the substrate dimension, the size of the display is merely about 2 to 3 inches. It can only be applied to small-size displays. With the advance of laser technology, an excimer laser annealing process is developed. In the aforementioned excimer laser annealing process, the the amorphous silicon thin film is illuminated using the laser beam so that the amorphous silicon thin film is melted and recrystallizes to form the polysilicon thin film. The process can be carried out at a temperature under 600° C. Therefore, the glass substrate with manufacturing costs lower than the quartz substrate can be applied to fabricate the polysilicon thin film transistor. Accordingly, it can be applied to fabricate large-dimension displays.

Prior art apparatuses for inspecting the quality of the polysilicon thin film include, for example, scanning electron microscopy (SEM), ellipsometer or deep UV microscopy. When scanning electron microscopy (SEM) is used to inspect surfaces of thin films, the substrate with thin film thereon should be cut into small pieces. The method is called a destructive test and effects the electrical property of the polysilicon thin film. Although ellipsometer can perform a non-destructive inspection to the polysilicon thin film for avoiding the damage to the surface of the sample, it needs high cost and longer time to inspect. The deep UV microscopy also has the disadvantage of high cost. Accordingly, the prior art inspection technology is limited thereto.

It should be noted that, during the laser annealing process, the film quality depends on the grain size and the other material properties. The material properties are dominated by the energy density of the laser beam used during the process. In prior art, after the inspection is complete, the result of the inspection is taken as reference for adjusting the energy density of the laser beam for obtaining the polysilicon thin film with better quality. However, the prior art inspection is performed after the processing of the whole batch is complete, and cannot be integrated during the annealing process. Therefore, the adjustment to the process parameters cannot be performed until processing the next batch. It cannot provide a real-time adjustment and efficiently improve yield rate and film quality.

### SUMMARY OF INVENTION

Accordingly, the present invention is directed to a laser annealing apparatus, which adapted for providing a real-time inspection during the laser annealing process and to optimize the energy density of the laser beam for improving yield rate and film quality.

The present invention is also directed to a laser annealing process, adapted for performing a real-time inspection after forming the polysilicon thin film, and to optimize the energy density of the laser beam, according to the inspection, for improving yield and film quality.

According to an embodiment of the present invention, a laser annealing apparatus, which is adapted for performing a laser annealing process for annealing an amorphous silicon thin film. The laser annealing apparatus comprises a laser-generating module, a resistance-measurement module and a host circuit module. The laser-generating module is adapted to provide a laser beam to recrystallize the amorphous silicon thin film to form a polysilicon thin film. The resistance-measurement module is adapted to measure a sheet resistance of the polysilicon thin film for obtaining a sheet resistance value. The host circuit module is electrically coupled to and between the laser-generating module and the resistance-measurement module. The host circuit module, according to the sheet resistance value, outputs a feedback signal to the laser-generating module for optimizing an energy density of the laser beam.

In an embodiment of the present invention, the laser annealing apparatus further comprises a supporting module, wherein the supporting module is moveably located between the laser-generating module and the resistance-measurement module. Also, the supporting module is electrically coupled to the host circuit module and adapted to support the amorphous silicon thin film for laser annealing process. After the recrystallization of the amorphous silicon thin film, the supporting module supports the polysilicon thin film to perform resistance measurement.

In the embodiment of the present invention, the resistance-measurement module comprises, for example, a measurement terminal and an output circuit, wherein the measurement terminal can be, for example, a probe set, adapted to measure the sheet resistance of the polysilicon thin film. The output circuit is electrically coupled to and between the measurement terminal and the host circuit module, adapted to output a signal represents the sheet resistance to the host circuit module.

In the embodiment of the present invention, the host circuit module, for example, is installed a database, wherein the database, for example, stores a plurality of referential resistance values. The host circuit module is adapted to compare the sheet resistance value and the referential resistance values for obtaining the feedback signal.

In the embodiment of the present invention, the laser-generating module comprises, for example, a laser beam source and a control circuit, wherein the laser beam source can be, for example, an excimer laser; and the control circuit is electrically coupled to and between the laser beam source and the host circuit module, adapted to receive the feedback signal form the host circuit module and to optimize the energy density of the laser beam according to the feedback signal.

According to the descriptions above, the present invention discloses a laser annealing process, comprising: (a) providing a laser beam to crystallize one of a plurality of amorphous silicon thin films to form a polysilicon thin film; (b) measuring a sheet resistance of the polysilicon thin film for obtaining a sheet resistance value; (c) comparing the sheet resistance value and a plurality of referential resistance values; and (d) optimizing an energy density of the laser beam according to the comparison of the sheet resistance value and the referential resistance values.

In an embodiment of the present invention, the laser annealing process further comprises: (e) providing the optimized laser beam to recrystallize another one of the amorphous silicon thin films to form another polysilicon thin film. In addition, the laser annealing process, for example, further comprises: repeating the steps (b) to (e) several times.

In an embodiment of the present invention, before the step (a), the laser annealing process further comprises: (f) individually providing the laser beam with different energy densities to a plurality of amorphous silicon thin film samples so as to recrystallize each amorphous silicon thin film sample to a polysilicon thin film sample; and (g) measuring sheet resistances of the polysilicon thin film samples, serving as the referential resistance values.

Accordingly, the laser annealing process performs a real-time inspection by integrating the resistance-measurement module in the laser annealing apparatus, for obtaining the sheet resistance value of the polysilicon thin film. Then, the sheet resistance value and the referential resistance values are compared. According to the comparison, the feedback signal is output to the laser-generating module for optimizing the energy density of the laser beam. Because the laser annealing apparatus can in real-time optimize the energy density of the laser beam source, yield rate and the film quality can be improved.

In order to make the aforementioned and other objects, features and advantages of the present invention understandable, a preferred embodiment accompanied with figures is described in detail below.

### BRIEF DESCRIPTION OF DRAWINGS

FIG. 1 is schematic drawing showing a laser annealing apparatus according to an embodiment of the present invention.

FIG. 2 is a figure showing the curves of the empirical parameters of the laser annealing process that include the energy density of the laser beam, the grain size and the sheet resistance value of the polysilicon thin film according to the present invention.

FIG. 3 is a process flow showing a preferred laser annealing process of the present invention.

### DETAILED DESCRIPTION

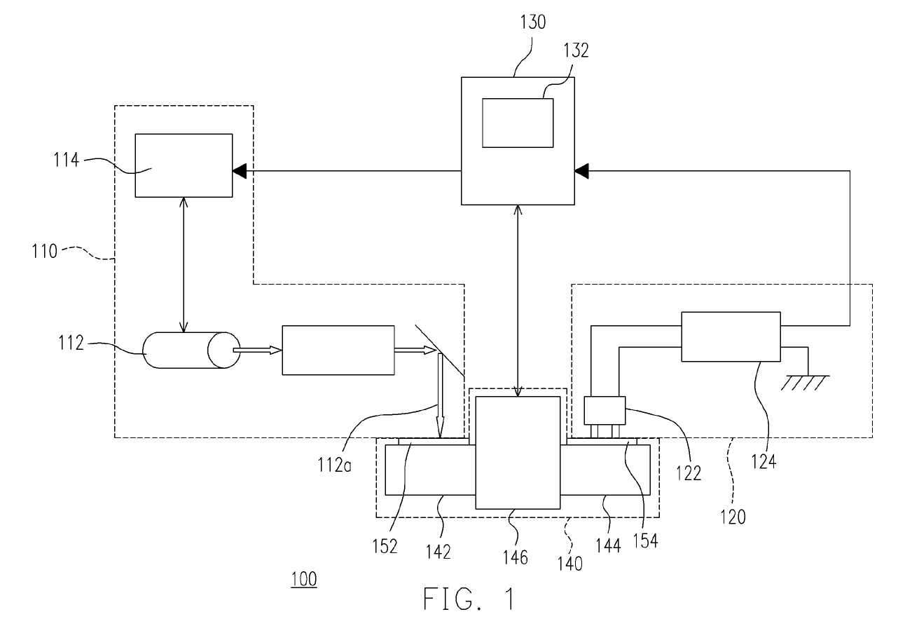

FIG. 1 is schematic drawing showing a preferred laser annealing apparatus of the present invention. Referring to FIG. 1, the laser annealing apparatus 100 is, for example, adapted for a laser annealing process. The laser annealing apparatus 100 comprises, for example, a laser-generating module 110, a resistance-measurement module 120, a host circuit module 130 and a supporting module 140. A first supporter 142 of the supporting module 140 supports is used to support a first substrate 152 with an unannealed amorphous silicon thin film; and a second supporter 144 of the supporting module 140 is used to support a second substrate 154 with an annealed polysilicon silicon thin film. In addition, a transferring apparatus 146 is disposed between the first supporter 142 and the second supporter 144, and adapted to transfer the substrate on the first supporter 142 to the second supporter 144.

Referring to FIG. 1, the host circuit module 130 is installed in, for example, a database 132. The database stores, for example, a plurality of empirical parameters of the laser annealing process, such as energy density of the laser beam, the sheet resistance values of polysilicon thin films responding thereto, or the grain sizes of the polysilicon thin films responding thereto. In addition, the resistance-measurement module 120 comprises, for example, a measurement terminal 122 and an output circuit 124. The measurement terminal 122 is, for example, a probe set which is disposed over the second supporter 144 and adapted to measure the sheet resistance of the polysilicon thin film on the second substrate 154. The output circuit 124 is electrically coupled to and between the measurement terminal 122 and the host circuit module 130, adapted to output a signal represents the sheet resistance value measured by the measurement terminal 122 to the host circuit module 130.

Referring to FIG. 1, the laser-manufacturing module 110 comprises, for example, a laser beam source 112 and a control circuit 114. The laser beam source 112 is, for example, an excimer laser, adapted to provide a laser beam 112a to the first substrate 152 for performing a laser annealing thereon. The control circuit 114 is electrically coupled to and between the host circuit module 130 and the laser beam source 112. When receiving the signal represents the sheet resistance value from the resistance-measurement module 120, the host circuit 130 outputs a feedback signal responding thereto to the control circuit 114 for optimizing the energy density of the laser beam 112a.

The laser annealing apparatus, according to an embodiment of the present invention, can in real-time measure the sheet resistance value of the polysilicon thin film during the laser annealing process, and optimize the energy density of the laser beam referring to the empirical parameters stored in the database. The empirical parameters of the laser annealing process can be obtained not only from the last annealing processes, but also from the annealing processes performed on a plurality of amorphous silicon thin film samples with different energy densities of laser beams for measuring the sheet resistance values and grain sizes of the formed polysilicon thin film samples as the empirical parameters.

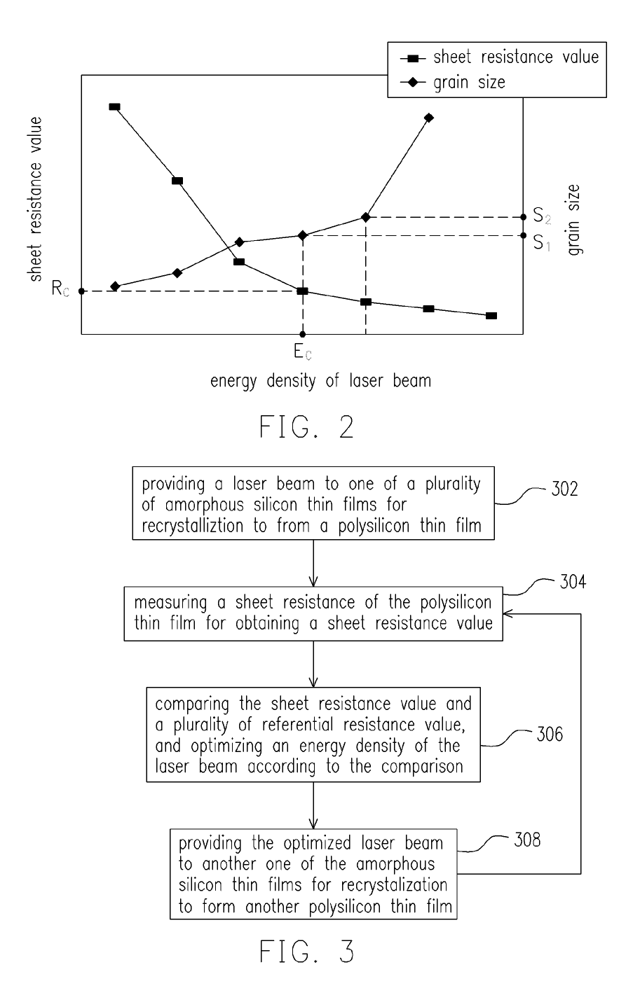

FIG. 2 is a figure showing the curves of the empirical parameters of the laser annealing process that include the energy density of the laser beam, the grain size and the sheet resistance value of the polysilicon thin film according to the present invention. The curve 210 represents the relation between the energy density of the laser beam and the sheet resistance value of the polysilicon thin film. The curve 220 represents the relation between the energy density of the laser beam and the grain size of the polysilicon thin film. For example, when the sheet resistance value of the polysilicon thin film is Rc, the energy density responding thereto is about Ec according to the curve 210, and the grain size is about S1 according to the curve 220. If the larger grain size S2 is desired, the energy density of the laser beam should be increased according to the trend of the curve 220 for obtaining the polysilicon thin film with larger grains. The laser annealing apparatus of the present invention can fabricate desired polysilicon thin film by consecutive feedback and adjusting operations.

According to the laser annealing apparatus described above, following are the descriptions of the laser annealing process applied thereto. FIG. 3 is a process flow showing a preferred laser annealing process of the present invention. The laser annealing process, according to an embodiment of the present invention, is adapted for annealing a plurality of amorphous silicon thin films. First, a laser beam is provided to one of the amorphous silicon thin films (step 302). Then, the sheet resistance of the polysilicon thin film is measured for obtaining a sheet resistance value (step 304). Next, a comparison between the sheet resistance value and referential resistance values is performed, and the energy density of the laser beam can be optimized according to the comparison (step 306). Then, the optimized laser beam is provided to recrystallize another amorphous silicon thin film to form another polysilicon thin film (step 308). Then the steps from 304 to 308 mentioned above are repeated to anneal the other amorphous silicon thin films.

Please referring to FIGS. 1-3, in step 302, the polysilicon thin film annealed by the laser beam 112a is formed on, and the second substrate is transferred to the second supporter 144 by the transferring apparatus 146. In step 304, the measurement terminal 122 measure the sheet resistance of the polysilicon thin film on the second substrate 154, and a signal represents the sheet resistance value is output to the host circuit module 130 via the output circuit 124. In step 306, the host circuit module 130 compares the sheet resistance value and the sheet resistance values stored in the database. For example, according to the curves 202 and 204 and a desired grain size, a feedback signal is output to the control circuit 114 of the laser-generating module 110. The control circuit 114, then, controls the laser beam source 112 and optimizes the energy density of the laser beam 112a by the feedback signal. In step 308, the optimized laser beam 112a is applied to anneal the amorphous silicon film formed on another first substrate 152. Combined with the steps described, a cycle of laser annealing process is performed.

Accordingly, during the laser annealing process, the laser annealing apparatus measures the sheet resistance value of the polysilicon thin film via the resistance-measurement module. Then, the sheet resistance value is compared with the empirical parameters of the last or sampling processes, and the energy density of the laser beam is optimized for obtaining the desired film quality. In addition, the laser annealing apparatus of the present invention can measure the sheet resistance value during the laser annealing process and optimize the energy density of the laser beam. Even if the process environment is changed or the material property is different, the energy density of the laser beam can be appropriately adjusted. The laser annealing apparatus of the present invention can optimize the energy density of the laser beam for obtaining better film quality and the yield rate of the laser annealing process.

Although the present invention has been described in terms of exemplary embodiments, it is not limited thereto. Rather, the appended claims should be constructed broadly to include other variants and embodiments of the invention, which may be made by those skilled in the field of this art without departing from the scope and range of equivalents of the invention.

1. A laser annealing apparatus, adapted to perform a laser annealing process for annealing an amorphous silicon thin film, comprising:
a laser-generating module, adapted to provide a laser beam to recrystallize the amorphous silicon thin film to form a polysilicon thin film;
a resistance-measurement module, adapted to measure a sheet resistance of the polysilicon thin film for obtaining a sheet resistance value; and
a host circuit module, electrically coupled to and between the laser-generating module and the resistance-measurement module, the host circuit module, according to the sheet resistance value, outputting a feedback signal to the laser-generating module, for optimizing an energy density of the laser beam.

2. The laser annealing apparatus of claim 1, further comprising a supporting module, wherein the supporting module is moveably located between the laser-generating module and the resistance-measurement module, adapted to support the amorphous silicon thin film, and electrically coupled to the host circuit module.

3. The laser annealing apparatus of claim 1, wherein the laser-generating module comprises:
a laser beam source; and
a control circuit, electrically coupled to and between the laser beam source and the host circuit module.

4. The laser annealing apparatus of claim 3, wherein the laser beam source comprises an excimer laser.

5. The laser annealing apparatus of claim 1, wherein the resistance-measurement module comprises:
a measurement terminal; and
an output circuit, electrically coupled to and between the measurement terminal and the host circuit module.

6. The laser annealing apparatus of claim 5, wherein the measurement terminal comprises a probe set.

7. The laser annealing apparatus of claim 1, wherein the host circuit module is installed in a database, and the host circuit module is adapted to compare the sheet resistance with a plurality of referential resistance values stored in the database for generating the feedback signal.

8-11. (canceled)
